(19) United States
(12) Patent Application Publication
(10) Pub. No.: US 2025/0252420 A1
(43) Pub. Date: Aug. 7, 2025

(54) Self-Checkout Method, System, Device and Kit

(71) Applicant: FLYTECH TECHNOLOGY CO., LTD., Taipei City (TW)

(72) Inventors: Tai-Seng LAM, Taipei City (TW); Shui-Chin TSAI, Taipei City (TW); Li-Chun CHOU, Taipei City (TW)

(21) Appl. No.: 18/646,932

(22) Filed: Apr. 26, 2024

(30) Foreign Application Priority Data
Feb. 7, 2024 (TW) 113105110

(51) Int. Cl. G06Q 20/20; G06Q 20/18

(52) U.S. Cl. CPC G06Q 20/208; G06Q 20/18

(57) ABSTRACT

The present invention relates to a self-checkout method. The method includes at a self-service terminal, executing following steps through a control module: continuously detecting the occurrence of a checkout interruption event; driving a plurality of sensors to capture a plurality of sensing information, executing a plurality of independent models to recognize the plurality of sensing information, thereby generating the plurality of recognition results, and determining whether the checkout interruption event has occurred accordingly; when the checkout interruption event occurs: disabling a first display device that provides a checkout operation, and forwarding the plurality of sensing information and the plurality of recognition results to a remote service station; and establishing a transmission connection with the remote service station, to allow a user to conduct a real-time communication with the remote service station through a second display device.

### CROSS-REFERENCE TO RELATED APPLICATION

This application claims priority benefit to Taiwan Invention patent application No. 113105110, filed on Feb. 7, 2024, in Taiwan Intellectual Property Office, the entire disclosures of which are incorporated by reference herein.

### FIELD

The present invention relates to a self-checkout method, system, device and kit, in particular to a self-checkout method, system, device and kit capable of providing a remote assistance in response to an occurrence of a checkout interruption event.

### BACKGROUND

With the rise in labor costs and the impact of the COVID-19 pandemic, many retailers have begun to implement self-checkout (SCO) technology or set up self-service terminals (SST) at checkout counters to provide consumers with a more convenient self-service checkout experience.

The main advantage of SCO technology is that it allows customers to complete their checkout process quickly, especially during busy shopping periods, which helps to reduce waiting time in queues. In addition, because SCO technology does not require cashier intervention and a single employee can supervise multiple SCO terminals simultaneously, it helps reduce the number of employees and associated labor costs. Particularly in traditional cashier checkout models, where cashier costs have always been a major expense, the introduction of SCO technology allows stores to operate more checkout points with fewer employees.

However, this new form of self-service checkout also introduces many new problems that need to be addressed. Common problems include customers being unfamiliar with the self-checkout process, not aligning the product barcode with the scanner, placing the product too far away from the scanner, or experiencing double checkout problems. Although most simple problems can be solved directly by the self-checkout terminal's built-in artificial intelligence without the need for back-end customer service intervention, there are still other problems that AI cannot solve and that require the assistance of back-end customer service personnel.

According to the current development of self-checkout technology, when a problem occurs at a checkout point, the SCO terminal does not provide detailed information about the problem to customer service personnel. Customer service personnel must rely on the customer's description to understand the problem. However, because customers are unfamiliar with self-checkout technology, these descriptions often do not provide sufficient information or allow customer service to quickly resolve the problem.

As a result, customer service personnel spend more time understanding and confirming the problem, which means they spend more time on a single issue and less time helping other customers with checkout problems. This not only causes more inconvenience and hassle for consumers, but also prevents customer service from monitoring other self-checkout points.

Hence, there is a need to solve the above shortcomings and deficiencies.

### SUMMARY

The present invention relates to a self-checkout method, system, device and kit, in particular to a self-checkout method, system, device and kit capable of providing a remote assistance in response to an occurrence of a checkout interruption event.

Accordingly, the present invention provides a self-checkout method. The method includes at a self-service terminal, executing following steps through a control module: continuously detecting the occurrence of a checkout interruption event; driving a plurality of sensors to capture a plurality of sensing information, executing a plurality of independent models to recognize the plurality of sensing information, thereby generating the plurality of recognition results, and determining whether the checkout interruption event has occurred accordingly; when the checkout interruption event occurs: disabling a first display device that provides a checkout operation, and forwarding the plurality of sensing information and the plurality of recognition results to a remote service station; and establishing a transmission connection with the remote service station, to allow a user to conduct a real-time communication with the remote service station through a second display device.

The present invention further provides a self-checkout system. The system includes: a self-service terminal comprising a control module configured to execute the following steps: continuously detecting the occurrence of a checkout interruption event; driving a plurality of sensors to capture a plurality of sensing information, executing a plurality of independent models to recognize the plurality of sensing information, thereby generating the plurality of recognition results, and determining whether the checkout interruption event has occurred accordingly; when the checkout interruption event occurs: disabling a first display device that provides a checkout operation, and forwarding the plurality of sensing information and the plurality of recognition results to a remote service station; and establishing a transmission connection with the remote service station, to allow a user to conduct a real-time communication with the remote service station through a second display device.

The present invention further provides a self-checkout device. The device includes: a control module configured to execute the following steps: continuously detecting the occurrence of a checkout interruption event; driving a plurality of sensors to capture a plurality of sensing information, executing a plurality of independent models to recognize the plurality of sensing information, thereby generating the plurality of recognition results, and determining whether the checkout interruption event has occurred accordingly; when the checkout interruption event occurs: disabling a first display device that provides a checkout operation, and forwarding the plurality of sensing information and the plurality of recognition results to a remote service station; and establishing a transmission connection with the remote service station, to allow a user to conduct a real-time communication with the remote service station through a second display device.

The present invention further provides a self-checkout kit that is attachable to a checkout management device. The kit includes: a control module, integrated within the checkout management device or configured separately from but communicatively connected with the checkout management device, configured to: continuously detect the occurrence of a checkout interruption event; drive a plurality of sensors to capture a plurality of sensing information, execute a plurality of independent models to recognize the plurality of sensing information, thereby generate the plurality of recognition results, and determine whether the checkout interruption event has occurred accordingly; when the checkout interruption event occurs: disable a first display device that provides a checkout operation, and forward the plurality of sensing information and the plurality of recognition results to a remote service station; and establish a transmission connection with the remote service station, to allow a user to conduct a real-time communication with the remote service station through a second display device.

The above content described in the summary is intended to provide a simplified summary for the presently disclosed invention, so that readers are able to have an initial and basic understanding to the presently disclosed invention. The above content is not aimed to reveal or disclose a comprehensive and detailed description for the present invention, and is never intended to indicate essential elements in various embodiments in the present invention, or define the scope or coverage in the present invention.

### DESCRIPTION OF THE DRAWINGS

A more complete appreciation according to the present invention and many of the attendant advantages thereof are readily obtained as the same become better understood by reference to the following detailed description when considered in connection with the accompanying drawing, wherein:

FIG. 1 is a schematic diagram illustrating the system architecture for the self-checkout system included in the present invention;

FIG. 2 is a schematic diagram illustrating the hardware architecture for the control module included in the present invention;

FIG. 3 is a block diagram illustrating the collaborative operation between the self-checkout software and various hardware components included in the present invention;

FIG. 4 is a schematic diagram illustrating the checkout interruption mode included in the present invention;

FIG. 5 is a block diagram illustrating the deep learning model included in the present invention;

FIG. 6 is a schematic diagram illustrating the system architecture for the first embodiment of the self-checkout separation kit included in the present invention;

FIG. 7 is a schematic diagram illustrating the system architecture for the second embodiment of the self-checkout separation kit included in the present invention;

FIG. 8 is a flow chart showing the implementation steps for the self-checkout method included in the present invention; and

FIG. 9 is a flow chart showing the implementation steps for the checkout interruption event determination method included in the present invention.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice. It is clear that other embodiments can be configured according to the knowledge of persons skilled in the art without departing from the authentic technical teaching of the present disclosure, the claimed disclosure being limited only by the terms of the appended claims.

It is to be noticed that the term “including,” used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

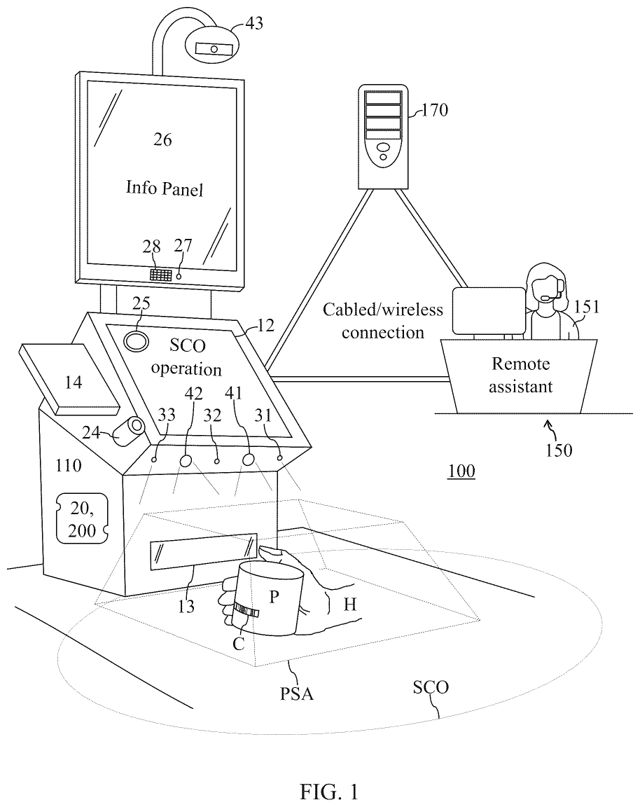

FIG. 1 is a schematic diagram illustrating the system architecture for the self-checkout system included in the present invention. In some embodiments, the self-checkout system (the self-checkout device) 100 preferably includes a self-service terminal 110, a remote service station 150, and an image server 170. The self-service terminal 110 includes a first display device 12, an information code sensor 13, a card reader 14, a first proximity sensor 31, a second proximity sensor 32, a third proximity sensor 33, a first image sensor 41, a second image sensor 42, a high-position image sensor 43, a control module 20, a physical remote assistance call button 24, a touch based remote assistance call button 25, a second display device 26, a microphone 27, and a speaker 28, wherein the control module 20 is equipped with self-checkout software 200.

The self-service terminal (SST) 110 is preferably an electronic device or host with point of sale (POS) functionality, or directly a POS terminal. It is equipped with a first display device 12, an information code sensor 13, a card reader 14, and a control module 20 to realize and implement the basic manual checkout functions of a POS terminal. The first display device 12 is preferably a touchscreen, the second display device 26 is preferably a flat panel display or a touchscreen, and the control module 20 is preferably configured within the self-service terminal 110 or externally connected to the internal control circuit of the self-service terminal 110 for communication.

At the lower part of the self-checkout system 100 or the self-service terminal 110, a product sensor group is arranged, which includes multiple sensors, such as but not limited to: the first proximity sensor 31, the second proximity sensor 32, the third proximity sensor 33, the first image sensor 41, the second image sensor 42, the high-position image sensor 43, and the information code sensor 13, etc. The product sensor group is preferably configured and positioned below the self-service terminal 110, to form a virtual three-dimensional product sensing area PSA in front of the self-service terminal 110.

In some embodiments, the first proximity sensor 31, the second proximity sensor 32, and the third proximity sensor 33 are preferably distance sensors, time of flight (TOF) sensors, multi-object tracking (MOT) sensors, gesture recognition sensors, optical motion trackers, motion sensors, proximity sensors, active infrared (AIR) sensors, passive infrared (PIR) sensors, or consumer infrared (CIR) sensors.

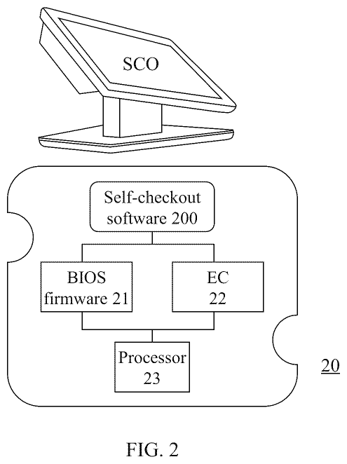

FIG. 2 is a schematic diagram illustrating the hardware architecture for the control module included in the present invention. The self-checkout method provided by the present invention is preferably implemented in the form of self-checkout software 200, which is a self-checkout computer program product installed on the control module 20 contained in the self-checkout system 100. The control module 20 includes at least a basic input/output system (BIOS) firmware 21, an embedded controller (EC) 22, and a processor 23 among other components.

The self-checkout software 200 is loaded by the processor 23 and executed jointly by the processor 23 and the EC 22, so as to implement the self-checkout method through the control module 20, and to facilitate various controls over the self-checkout system 100.

The control module 20 is configured to define and set up a certain area around the product sensing area PSA as a virtual self-checkout region SCO, and then, based on the images captured by the high-position image sensor 43, detects whether a user has entered the self-checkout region SCO to correspondingly initiate the self-checkout process.

If no customers enter the self-checkout region SCO, the control module 20 switches the second display device 26 and the first display device 12 to an advertising mode that plays predefined advertising content, and controls the product sensor group including multiple sensors to enter a low power standby state, thereby reducing the overall power consumption of the self-checkout system 100.

When the control module 20 determines that a user has entered the self-checkout region SCO based on the images captured by the high position image sensor 43, it initiates the execution of the self-checkout process. Similarly, if the control module 20 determines that any sensor included in the product sensor group is triggered, it also initiates the execution of the self-checkout process, including switching the second display device 26 and the first display device 12 to checkout mode.

Upon entering the checkout mode, the first display device 12 displays the self-checkout operation interface for users to perform self-checkout operations, while the second display device 26 displays checkout assistance information, such as, but not limited to: guidance on the standard operating procedures for self-checkout, showing and explaining the steps of the self-checkout operations to users.

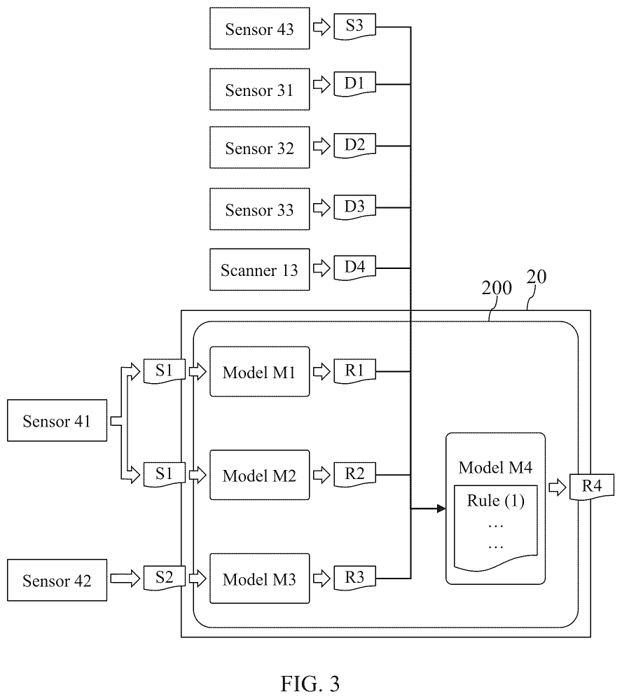

FIG. 3 is a block diagram illustrating the collaborative operation between the self-checkout software and various hardware components included in the present invention. The self-checkout software 200 operates through the control module 20 and includes four independent models: a gesture recognition independent model M1, an information code recognition independent model M2, an object recognition independent model M3, and a checkout assistance decision independent model M4. In some embodiments, these independent models M1-M4 are preferably executed by the control module 20 at the device end or at the local end to enable edge computing.

In some embodiments, the first proximity sensor 31, the second proximity sensor 32, and the third proximity sensor 33 are preferably time of flight sensors. The first proximity sensor 31 is preferably configured to sense the first distance information regarding the hand H, the information codes C labeled on the product P, or the product P within the product sensing area PSA, and to generate the first distance sensing information D1. The second proximity sensor 32 is preferably configured to sense the second distance information regarding the hand H, information codes C labeled on the product P, or the product P within the product sensing area PSA, and to generate the second distance sensing information D2. The third proximity sensor 33 is preferably configured to sense the third distance information regarding the hand H, the information codes C labeled on the product P, or the product P within the product sensing area PSA, and to generate the third distance sensing information D3. The information code sensor 13 is preferably configured to read the information codes C labeled on the product P within the product sensing area PSA, and to generate the fourth information code sensing information D4.

The first image sensor 41 is preferably configured to capture a first image sensing information S1 within the scope of the product sensing area PSA, including the hand H and the information codes C appearing on the product P. The second image sensor 42 is preferably configured to capture the second image sensing information S2 within the scope of the product sensing area PSA, including the product P, wherein the product P preferably has the information codes C that can be read by the information code sensor 13. The form of the information code includes but is not limited to: one-dimensional barcodes and two-dimensional QR codes, etc. The information code C is used to store various information, including but not limited to product names, places of production, manufacturers, production dates, product prices, etc.

The high-position image sensor 43 is preferably configured in a place at the top position of the self-checkout system 100. For example, the high-position image sensor 43 is integrated into the upper frame of the second display device 26 or mounted on a bracket or casing at the top of the second display device 26. By being positioned at a higher location, the high-position image sensor 43 is capable of acquiring a larger and wider field of view (FOV), panoramically capturing and recording the complete self-checkout process performed by a user, and generating third image sensing information S3.

After the self-checkout process is initiated and performed, the control module 20 is preferably configured to drive the first display device 12 to selectively generate a touch based remote assistance call button 25, and to continuously detect in the background whether the physical remote assistance call button 24 or the touch based remote assistance call button 25 is pressed throughout the entire self-checkout process.

In some embodiments, the control module 20 is preferably configured to feed the real-time image of the first image sensing information S1 captured by the first image sensor 41 into both the gesture recognition independent model M1 and the information code recognition independent model M2, so as to identify whether the first image sensing information S1 contains a hand and a gesture skeleton, to recognize if the gesture skeleton includes a checkout gesture signifying the intent to checkout, and to output the first recognition result R1, by the gesture recognition independent model M1, and so as to identify the information code contained in the first image sensing information S1, and to output the second recognition result R2, by the information code recognition independent model M2.

In some embodiments, the control module 20 is preferably configured to input the real-time image of the second image sensing information S2 captured by the second image sensor 42 immediately into the object recognition independent model M3, to identify whether the second image sensing information S2 contains products and their names and to output the third recognition result R3 by the object recognition independent model M3.

In some embodiments, the control module 20 is preferably configured to feed the first recognition result R1, the second recognition result R2, and the third recognition result R3 into the checkout assistance decision independent model M4, to output the fourth recognition result R4.

In some embodiments, the checkout assistance decision independent model M4 is preferably a rule-based machine learning model that serves as a self-checkout assistance decision model. As shown in FIG. 3, the checkout assistance decision independent model M4 receives all distance sensing information D1-D3, information code sensing information D4, all image sensing information S1-S3, and all recognition results R1-R3 generated by the self-checkout system 100. Then the checkout assistance decision independent model M4 is configured to identify a consuming behavior based on built-in default rules and to determine whether any product was missed scanning during the self-checkout process based on built-in default rules, and to output the fourth recognition result R4.

By increasing the number of built-in default rules within the checkout assistance decision independent model M4 and optimizing these rules, the comprehensive capabilities of the model M4 can be significantly enhanced. For example, the checkout assistance decision independent model M4 includes, but is not limited to, the following rules:

The first category of rules may, upon execution, determine whether a non-checkout interruption event has occurred. The first category of rules includes:

Rule 1.1: Determine whether a barcode out-of-range event has occurred.

When the third proximity sensor 33 detects that the distance between the product P and the information code sensor 13 is greater than the effective sensing range of the information code sensor 13, and the second recognition result R2 indicates that the information code C labeled on the product P has been successfully captured, and the user's gesture skeleton includes a checkout action, the control module 20 determines that the barcode is placed at a position too far beyond the reading range of the information code sensor 13, causing a barcode out-of-range event. The control module 20 is configured to control the first display device 12 to display a prompt message advising the user to move the product closer to the information code sensor 13.

Rule 1.2: Determine whether a barcode misalignment event has occurred.

When the third recognition result R3 indicates a product has been successfully recognized and the second recognition result R2 indicates that the user's gesture skeleton includes a checkout action, but the information code sensor 13 fails to capture the information code, the control module 20 determines that a barcode misalignment event has occurred. The control module 20 is configured to control the first display device 12 to display a product scan failure prompt message, advising the user to check out again whether the product's barcode is aligned with the information code sensor 13.

Rule 1.3: Determine whether a double checkout event has occurred.

When the third recognition result R3 indicates that the detected number of products is N1, but the number of products scanned by the information code sensor 13, N2, is not equal N1, and N2 is greater than N1, it is determined that a double checkout event has occurred. The control module 20 is configured to control the first display device 12 to display a double checkout prompt message, advising the user to check again to see whether a double checkout has occurred.

In some embodiments, if a double checkout event occurs, the first display device 12 is configured to display a “Continue with checkout?” message to the customer. If the customer elects to continue, the first display device 12 is configured to display “Please replace the scanned product and continue,” and to resume the self-checkout process. If the customer chooses not to continue, the self-checkout process is terminated.

Rule 1.4: Determine whether a non-sale-area product event has occurred.

When the third recognition result R3 indicates that the detected product is not found in the product inventory list, it is determined that a non-sale-area product event has occurred. The control module 20 is configured to control the first display device 12 to display a non-sale-area product prompt message, advising the user to confirm whether the being checked out comes from the current market or not.

In some embodiments, if a non-sale-area product event occurs, the first display device 12 is configured to display a “Continue with checkout?” message to the customer. If the customer elects to continue, the first display device 12 is configured to display “Please replace the scanned product and continue,” and proceed with the self-checkout process. If the customer chooses not to continue, the self-checkout process is terminated.

The second category of rules may, upon execution, determine whether a checkout interruption event has occurred. When the checkout assistance decision independent model M4 determines that a checkout interruption event has occurred, it is configured to command the control module 20 to force the self-checkout process to enter the checkout interruption mode, in order to temporarily suspend the self-checkout process. The second category of rules includes:

Rule 2.1: Determine whether a missed scan event has occurred.

When the third recognition result R3 indicates that the detected number of products is N1, but the number of products successfully scanned by the information code sensor 13, N2, is not equal N1, and N1 is greater than N2, it is determined that a missed scan event has occurred. The control module 20 is configured to control the first display device 12 to display a missed scan prompt message, advising the user to check if any product has been missed scanning. If N1 continues to be greater than N2, the control module 20 is configured to lock out the screen of the first display device 12 and to disable the first display device 12 to temporarily suspend the self-checkout process, and to notify the remote assistant 151 at the remote service station 150.

Rule 2.2: Determine whether a checkout anomaly event has occurred.

When the third recognition result R3 indicates that the detected product P has suddenly disappeared, it is determined that a checkout anomaly event has occurred. The control module 20 is configured to lock out the screen of the first display device 12 and to disable the first display device 12 to temporarily suspend the self-checkout process, and to notify the remote assistant 151 at the remote service station 150.

Rule 2.3: Determine whether a first type remote assistance call event has occurred.

When the control module 20 detects that the physical remote assistance call button 24 has been pressed, it is configured to lock out the screen of the first display device 12 and to disable the first display device 12 to temporarily suspend the self-checkout process, and to notify the remote assistant 151 at the remote service station 150.

Rule 2.4: Determine whether a second type remote assistance call event has occurred.

When the control module 20 detects that the touch based remote assistance call button 25 has been pressed, it is configured to lock out the screen of the first display device 12 and to disable the first display device 12 to temporarily suspend the self-checkout process, and to notify the remote assistant 151 at the remote service station 150.

In some embodiments, during the entire self-checkout process, the control module 20 is preferably configured to drive the communication unit configured within the self-service terminal 110 to establish a peer-to-peer (P2P) connection, either wireless or wired, with the remote image server 170. It then drives the communication unit to execute a streaming protocol, such as but not limited to a real-time streaming protocol (RTSP), to transmit the current checkout dataset, including all real-time images captured by all image sensing information S1-S3, all sensing information D1-D4, and all recognition results R1-R4, to the image server 170 and to store them on the image server 170. If the system detects any issues occurred during the checkout process or a checkout interruption event occurs, the remote assistant 151 can retrieve the stored current checkout dataset and review the issues.

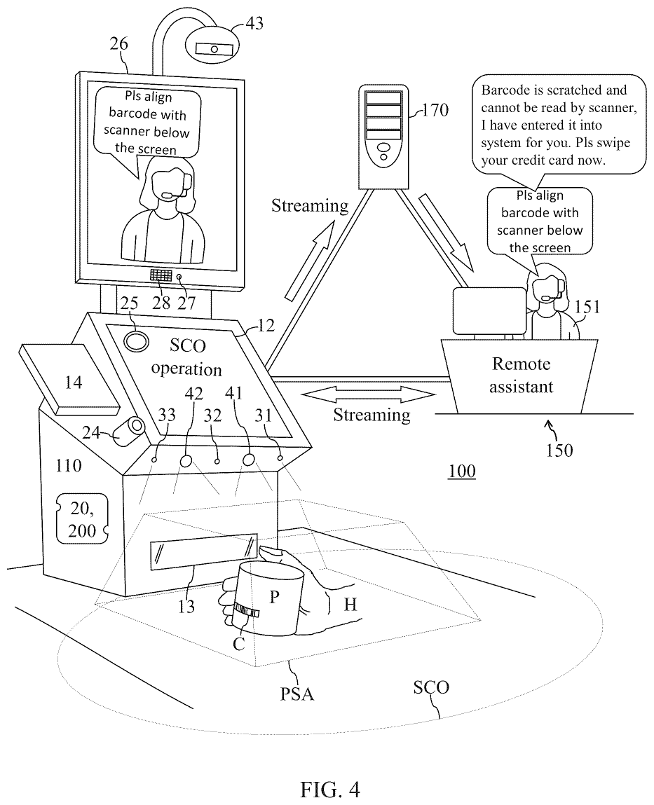

FIG. 4 is a schematic diagram illustrating the checkout interruption mode included in the present invention. When the control module 20 identifies that a checkout interruption event has occurred, it forces the self-checkout process to enter the checkout interruption mode, which includes locking out and disabling the screen of the first display device 12 to temporarily suspend the self-checkout process, and simultaneously commanding the cloud-based image server 170 to transmit the recorded and stored checkout dataset to the remote service station 150.

Subsequently, the control module 20 is also configured to instruct the communication unit to establish a communication connection with the remote service station 150, such as but not limited to a peer-to-peer connection, a local area network (LAN) connection, a wireless network connection, or a USB OTG connection. Once the communication connection is successfully established, a customer can interact with the remote assistant 151 at the remote service station 150 in real-time audio and video streaming communication through devices such as the second display device 26, microphone 27, and speaker 28.

Upon receiving the checkout dataset from the cloud-based image server 170, the remote assistant 151 can immediately review the image data, recognition results, and sensing information included in the dataset to fully understand and identify the problems encountered during the checkout process as early as possible, especially at a very early stage. After identifying the problem, the remote assistant 151 can then guide and assist the customer to perform the correct operations through real-time audio and video streaming communication, thereby quickly resolving the problem and returning the checkout process to the normal self-checkout process. In addition, the remote assistant 151 can assist customers with various tasks including, but not limited to, debugging, troubleshooting, system diagnostics, remote assistance operations, analysis, and configuration.

The present invention utilizes remote assistance, which provides problem resolution services in both a market-side and a customer-side aspect, to address problems that exist in the traditional self-checkout domain. The system provided by the present invention provides a remote assistance calling interface that is not limited to physical buttons or touch methods, as well as other interfaces that can trigger problem resolution functions. When customers, whether on the sales side or on the customer side, encounter problems or situations while using the system, they can invoke the remote problem resolution function through this interface. In terms of remote functionality, the system can also remotely connect to the SST for system operation, system diagnosis, troubleshooting, etc. through interfaces such as connecting to a LAN through a LAN jack or performing system diagnosis through USB OTG functionality, without any limitation on the type of remote functionality interface.

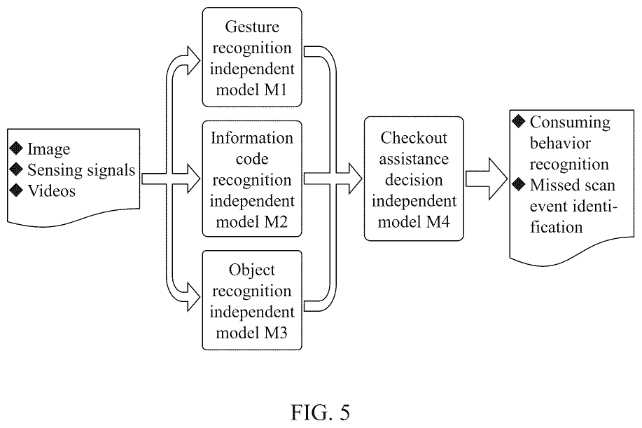

FIG. 5 is a block diagram illustrating the deep learning model included in the present invention. In the present invention, multiple independent small models that perform different recognition tasks are used instead of integrated large models. Typically, large models not only occupy memory space, but also consume significant computational power and memory. By splitting into task-specific independent small models, both the storage space occupied by all small models and the demand for computational power and memory are significantly reduced. In addition, these small models can directly apply pre-trained models, further reducing the cost of model training, or use open source models to further reduce the cost of model construction.

In general, large supervised deep learning models require a large amount of labeled training data for training, and more labeled training data means higher development costs. Moreover, if large supervised deep learning models can be divided into several smaller models for separate training before training integration, it would be easier to converge than direct end-to-end training.

Based on these two principles, the present invention provides a training method and decision system for detecting consumer checkout behavior by combining multiple shared smaller models in series instead of a single large end-to-end model, thereby reducing the difficulty and cost of training models.

In the present invention, model training is performed in two different stages. In the first stage of model training, each model is trained individually or using existing models and weights for transfer learning. The second stage of training then connects the trained small models to complete the end-to-end training of a large model.

In some embodiments, the gesture recognition independent model M1 is preferably a Convolutional Neural Network (CNN), a 3D Convolutional Neural Network (3D CNN), a Region-CNN (R-CNN), a Graph Convolutional Network (GCN), a Long Short-Term Memory (LSTM), a Bidirectional LSTM (Bi-LSTM), a Temporal Convolutional Network (TCN), an OpenPose model, a GestureNet model, a BlazePalm model, a Landmark model, a MediaPipe model, a Rekognition model, a Support Vector Machine (SVM), or a combination thereof.

In some embodiments, the information code recognition independent model M2 is preferably a ZBar model, an OpenCV model, a PyZbar model, a Google Vision model, or a combination thereof. The object recognition independent model M3 is preferably a YOLO (You Only Look Once) model, a SSD (Single Shot MultiBox Detector) model, a Faster R-CNN model, a Mask R-CNN model, a ResNet model, an EfficientDet model, an EfficientNet model, a VGG model, a VGGNet model, a COCO model, a CNN model, a MobileNet model, an AlexNet model, a GoogLeNet model, or a combination thereof.

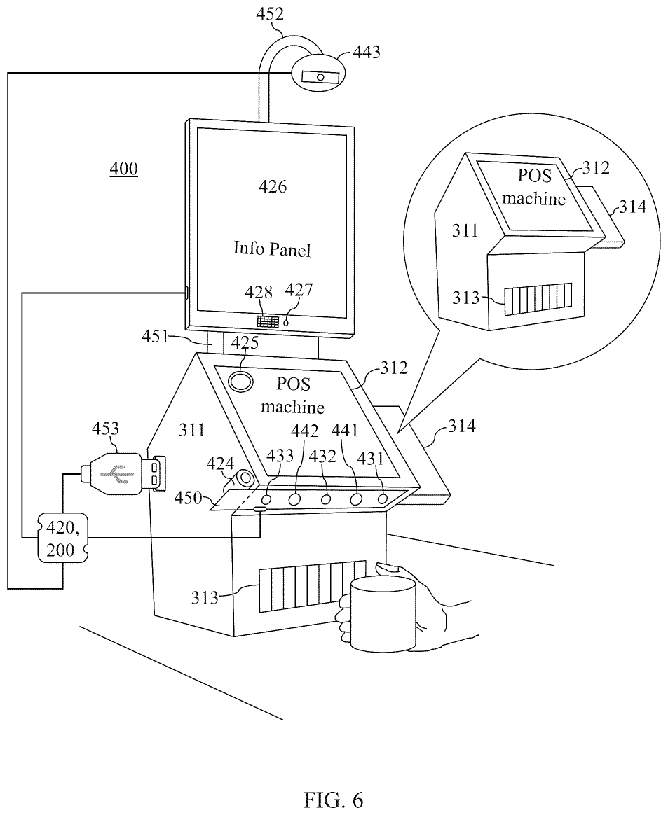

FIG. 6 is a schematic diagram illustrating the system architecture for the first embodiment of the self-checkout separation kit included in the present invention. In some embodiments, the self-checkout method provided by the present invention is further reduced to practice and implemented in the form of a self-checkout separation kit 400.

The existing checkout management devices 311, such as POS machines and cash registers, typically do not support user-operated self-checkout and require a dedicated in-house personnel to manually perform the checkout processes, including scanning product barcodes and operating the checkout interface to complete checkout actions. However, the existing checkout management devices 311 are already equipped with basic hardware components such as basic control circuits, first display device 312, the information code sensor 313, and the card reader 314. By additionally linking and connecting a group of product sensors, the information flat panel, and the self-checkout software 200, the existing checkout management devices 311 can be upgraded to the self-checkout devices with self-checkout functionality.

Therefore, the present invention further provides a self-checkout separation kit 400 that can provide the existing checkout management devices 311 with additional components needed for upgrading to self-checkout devices, including the first proximity sensor 431, the second proximity sensor 432, the third proximity sensor 433, the first image sensor 441, the second image sensor 442, a high-position image sensor 443, a control module 420, a physical remote assistance call button 424, a touch based remote assistance call button 425, a second display device 426, a microphone 427, and a speaker 428, wherein the control module 420 is already installed with the self-checkout software 200. After installing the self-checkout separation kit 400 according to the present invention, the existing checkout management devices 311 can be easily transformed into self-checkout devices with self-checkout functionality. The self-checkout separation kit 400 can enable the existing checkout management devices 311 with self-checkout functionality.

In some embodiments, the group of product sensors including the first proximity sensor 431, the second proximity sensor 432, the third proximity sensor 433, the first image sensor 441, the second image sensor 442 and the physical remote assistance call button 424, are preferably integrated into a single product sensor assembly 450 and attached to the lower part of the checkout management device 311. The second display device 426 is preferably configured and mounted at a position around the top of the checkout management device 311 by using a first bracket 451 or placed on one side of the checkout management device 311. The high-position image sensor 443 may also be mounted at a position higher than the checkout management device 311 by using a second bracket 452.

In some embodiments, components such as the first proximity sensor 431, the second proximity sensor 432, the third proximity sensor 433, the first image sensor 441, the second image sensor 442, the high-position image sensor 443, the control module 420, the physical remote assistance call button 424, the second display device 426, the microphone 427, and the speaker 428, are configured to communicate with the checkout management device 311 through appropriate communication interfaces, such as USB or HDMI transmission interfaces. In some embodiments, the control module 420 is preferably communicatively connected to the checkout management device 311 by using a USB OTG (On-The-Go) transmission interface.

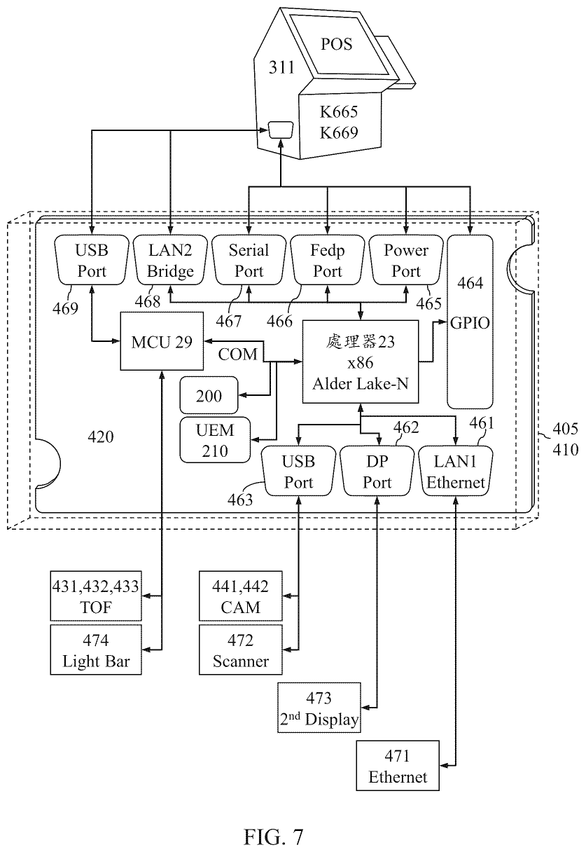

FIG. 7 is a schematic diagram illustrating the system architecture for the second embodiment of the self-checkout separation kit included in the present invention. In this embodiment, the control module 420 included in the self-checkout separation kit 400 is configured separately from the checkout management device 311. The control module 420 is configured within a box-shaped enclosure 405 to form an independent external control box 410, which is communicatively connected to the checkout management device 311.

In some embodiments, the control module 420 is equipped with an x86 architecture processor 23, such as, but not limited to, the Alder Lake N series processor, which serves as the microcontroller (MCU) 29 for the embedded controller (EC). The control module 420 is installed with and executes the self-checkout software 200 via the processor 23.

In addition, the control module 420 is installed with the unified endpoint management (UEM/inefi) software 210, which is executed by the processor 23 and allows an administrator to remotely manage the checkout management device 311 and integrate it as part of the Internet of Things (IoT) network.

The Unified Endpoint Management (UEM) software 210 is a cross-device software based on hardware-agnostic principles, preferably aggregating, managing, and protecting all certified endpoint devices within a specific organization. Endpoint devices include, but are not limited to, a point of sale (POS) devices, a kiosk, a self-checkout (SCO) device, a self-service device, a peripheral device, a panel PC, a workstation, a mobile device, a laptop, and a desktop computer.

The UEM software 210 includes a remote management console that provides administrators to remotely configure, monitor, manage, and protect these endpoint devices, regardless of their hardware type or operating system. The UEM software 210 also records the operating status for the self-checkout software 200, allowing users to query the operating information for the self-checkout software 200 through the remote management console.

The control module 420 is equipped with various communication connectors, including, but not limited to: a first network connector 461 such as an Ethernet connector, a display port connector 462, a first USB connector 463, a general purpose input/output (GPIO) port connector 464, a communication power connector 465 such as a USB Type-C PD, USB OTG, or PoE connector, a Fedp connector 466, a serial communication port (COM port) connector 467, a second network connector 468 such as an RJ45 connector, a second USB port 469, and so on.

The control module 420 preferably receives the necessary power from the checkout management device 311 through the communication power connector 465, thereby eliminating the need for an additional electrical connection to a fixed power source such as a wall outlet. It simplifies the installation process for the external control box 410, which increases the convenience and flexibility of deploying the external control box 410 and facilitates easier deployment for any user.

The control module 420 includes two network connectors, allowing the external control box 410 to access the network 471, including the Internet, intranet, and LAN, through the first network connector 461. Then, using the second network connector 468 as a bridge, it directly shares the network connection with the cash register management device 311, facilitating easier deployment for users.

The first USB connector 463 is preferably used to connect the first image sensor 441, the second image sensor 442, and the scanner 472, while the display port connector 462 is provided for connecting an external second display 473 or a customer display.

The MCU 29 is preferably used to control lower level hardware and peripheral devices, such as the first proximity sensor 431, the second proximity sensor 432, the third proximity sensor 433, and the indicator 474, for example. In this embodiment, the first proximity sensor 431, the second proximity sensor 432, and the third proximity sensor 433 are preferably TOF sensors, and the indicator 474 is preferably a light bar.

For example, the MCU 29 is preferably programmed to control the indicator 474 by executing algorithms such as, but not limited to, a pulse width modulation (PWM) algorithm. MCU 29 is configured to control the first proximity sensor 431, the second proximity sensor 432, and the third proximity sensor 433 through the I2C communication protocol and connect with the checkout management device 311 via the second USB port 469.

In addition, the MCU 29 may be used to perform hardware simulation tasks, including, but not limited to, simulating input/output interfaces and peripheral devices. For example, since the scanner 472 must be connected to the external control box 410, the MCU 29 is configured to simulate the scanner 472 and report back to the checkout management device 311.

When the checkout management device 311 needs to retrieve and view real-time images captured by the first image sensor 441 or the second image sensor 442, the processor 23 is configured to execute the RTSP protocol between the checkout management device 311 and the image server 170 to report the live images back to the checkout management device 311.

Since the external control box 410 and the self-checkout software 200 jointly form an independent self-checkout system that is separate from the existing checkout management device 311, when the checkout management device 311 requires to query the status of the external control box 410, such as the status of the first proximity sensor 431, the second proximity sensor 432, the third proximity sensor 433, the indicator 474, the first image sensor 441, the second image sensor 442, the second display 473, and the self-checkout software 200, the external control box 410 provides the following multiple access modes for the checkout management device 311 to perform an information query.

In the first access mode, a microcontroller command set is used, wherein the checkout management device 311 sends MCU commands to the MCU 29 through the serial communication port (COM port) 467. The MCU then reports back information based on the commands to the checkout management device 311 via the second USB port 469. The second access mode allows the checkout management device 311 to directly read each pin included in the general purpose input/output (GPIO) port connector 464 to obtain corresponding information based on the pin definitions of the GPIO port connector 464.

The third access mode involves querying information over the Internet from the remote management console of the Unified Endpoint Management (UEM) software 210. The UEM software 210 records all operating information of the external control box 410, including operating parameters and statuses of components such as the proximity sensors, the display, the image sensors, the second display, and the self-checkout software 200, among others. In addition, the checkout management device 311 can access the required operational information of the external control box 410 using the APIs or SDKs provided by the UEM software 210.

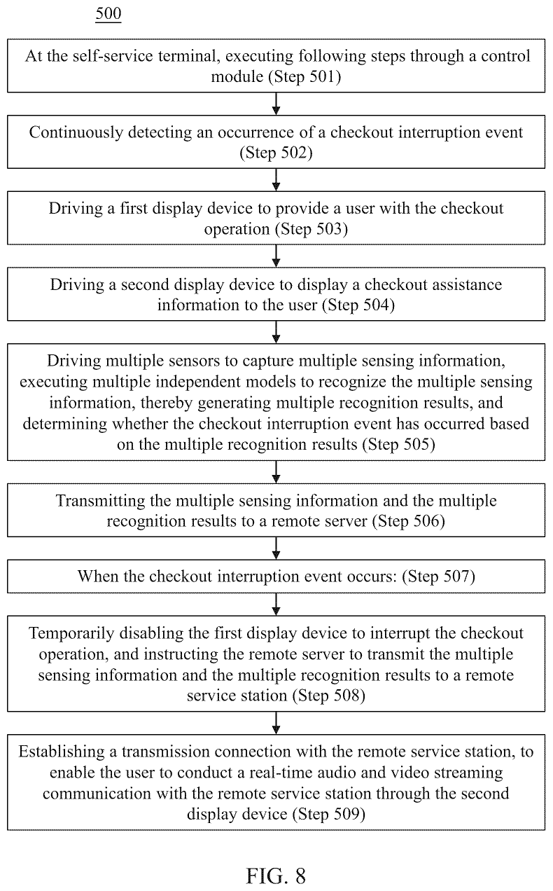

FIG. 8 is a flow chart showing the implementation steps for the self-checkout method included in the present invention. The self-checkout method 500 preferably includes, but is not limited to, the following steps: at the self-service terminal, executing following steps through a control module (Step 501): continuously detecting an occurrence of a checkout interruption event (Step 502); driving a first display device to provide a user with the checkout operation (Step 503); driving a second display device to display a checkout assistance information to the user (Step 504); driving multiple sensors to capture multiple sensing information, executing multiple independent models to recognize the multiple sensing information, thereby generating multiple recognition results, and determining whether the checkout interruption event has occurred based on the multiple recognition results (Step 505); transmitting the multiple sensing information and the multiple recognition results to a remote server

(Step 506); when the checkout interruption event occurs: (Step 507); temporarily disabling the first display device to interrupt the checkout operation, and instructing the remote server to transmit the multiple sensing information and the multiple recognition results to a remote service station (Step 508); and establishing a transmission connection with the remote service station, to enable the user to conduct a real-time audio and video streaming communication with the remote service station through the second display device (Step 509).

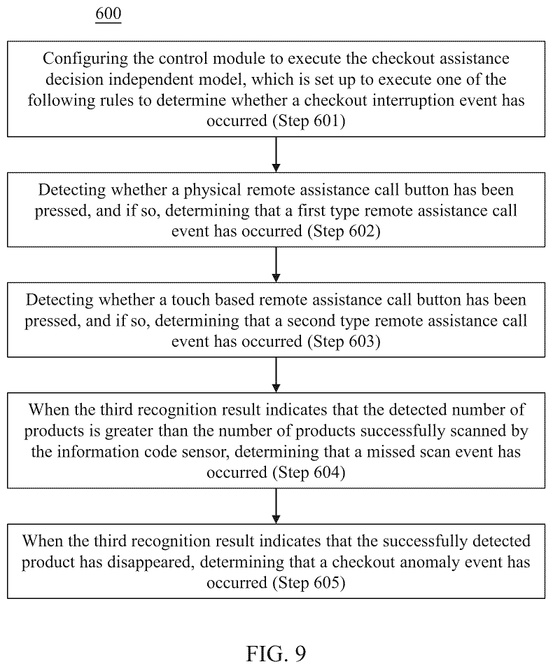

FIG. 9 is a flow chart showing the implementation steps for the checkout interruption event determination method included in the present invention. The checkout interruption event determination method 600 preferably includes, but is not limited to, the following steps: configuring the control module configured to execute the checkout assistance decision independent model, which is set up to execute one of the following rules to determine whether a checkout interruption event has occurred (Step 601): detecting whether a physical remote assistance call button has been pressed, and if so, determining that a first type remote assistance call event has occurred (Step 602); detecting whether a touch based remote assistance call button has been pressed, and if so, determining that a second type remote assistance call event has occurred (Step 603); when the third recognition result indicates that the detected number of products is greater than the number of products successfully scanned by the information code sensor, determining that a missed scan event has occurred (Step 604); and when the third recognition result indicates that the successfully detected product has disappeared, determining that a checkout anomaly event has occurred (Step 605).

The present invention is focus to establish an independent and complete system for supporting the checkout process in sales venues, providing a more convenient, automated, simple, accurate and remotely supported checkout system. The system provided by the present invention provides comprehensive assistance procedures before, during, and after the checkout stages in the sales system. By automatically detecting customer behavior and switching the current operating mode of the system, it provides customers with a self-service and automated checkout process while also providing comprehensive sales support to the sales venue.

The complete system architecture in the present invention integrates human sensing, artificial intelligence image recognition, software services, and problem resolution into a unified service. The entire system functions as an independent entity and provides a one-stop service without the need for human intervention or the involvement of other system equipment, thereby enabling a comprehensive automatic sales service.

The self-checkout method provided by the present invention helps remote assistants or customer service personnel to quickly identify problems and promptly intervene when problems arise, assisting customers in addressing and resolving problems, thereby improving the smoothness and efficiency of the entire self-checkout process.

There are further embodiments provided as follows.

Embodiment 1: A self-checkout method includes: at a self-service terminal, executing following steps through a control module: continuously detecting an occurrence of a checkout interruption event; driving a plurality of sensors to capture a plurality of sensing information, executing a plurality of independent models to recognize the plurality of sensing information, thereby generating the plurality of recognition results, and determining whether the checkout interruption event has occurred accordingly; when the checkout interruption event occurs: disabling a first display device that provides a checkout operation, and forwarding the plurality of sensing information and the plurality of recognition results to a remote service station; and establishing a transmission connection with the remote service station, to allow a user to conduct a real-time communication with the remote service station through a second display device.

Embodiment 2: The self-checkout method as described in Embodiment 1 further includes: at the self-service terminal, executing following steps through the control module: driving the first display device to provide the user with the checkout operation; driving the second display device to display a checkout assistance information to the user; driving the plurality of sensors to capture the plurality of sensing information; transmitting the plurality of sensing information and the plurality of recognition results to a remote server; and when the checkout interruption event occurs: temporarily disabling the first display device to interrupt the checkout operation, and instructing the remote server to transmit the plurality of sensing information and the plurality of recognition results to the remote service station; and establishing the transmission connection with the remote service station, to enable the user to conduct a real-time audio and video streaming communication with the remote service station through the second display device.

Embodiment 3: The self-checkout method as described in Embodiment 2 further includes: at the self-service terminal, executing the following steps through the control module: driving a first image sensor to capture a first image sensing information containing a hand or an information code; driving a second image sensor to capture a second image sensing information containing a product; executing a gesture recognition independent model to recognize the first image sensing information and generating a first recognition result accordingly; executing an object recognition independent model to recognize the second image sensing information and generating a third recognition result accordingly; inputting the first and third recognition results into a checkout assistance decision independent model and executing the checkout assistance decision independent model to determine whether a missed scan event has occurred accordingly; and when a missed scan event occurs: determining that a checkout interruption event has occurred.

Embodiment 4: The self-checkout method as described in Embodiment 3 further includes: at the self-service terminal, executing the following steps through the control module: driving a high-position image sensor to capture a third image sensing information containing the user, the hand, the product, or the information code; driving a first proximity sensor to detect a first distance information with respect to the hand, the product, or the information code, and obtaining a first sensing information accordingly; driving a second proximity sensor to detect a second distance information with respect to the hand, the product, or the information code, and obtaining a second sensing information accordingly; driving a third proximity sensor to detect a third distance information with respect to the hand, the product, or the information code, and obtaining a third sensing information accordingly; driving an information code sensor to read the information code, and obtaining a fourth sensing information accordingly; executing an information code recognition independent model based on the first image sensing information to produce a second recognition result; inputting the first to third recognition results, the first to third image sensing information, and the first to fourth sensing information into the checkout assistance decision independent model, executing the checkout assistance decision independent model to recognize a consuming behavior for the user and determining whether a missed scan event has occurred; and when a missed scan event occurs: determining that a checkout interruption event has occurred.

Embodiment 5: The self-checkout method as described in Embodiment 4 further includes: executing one of the following steps through the control module: selectively driving the first display device to generate a touch based remote assistance call button; and detecting whether a physical remote assistance call button or the touch based remote assistance call button has been pressed.

Embodiment 6: The self-checkout method as described in Embodiment 5, the checkout assistance decision independent model is configured to execute one of the following rules to determine whether the checkout interruption event has occurred: determining that a first type remote assistance call event has occurred, when the physical remote assistance call button is pressed; determining that a second type remote assistance call event has occurred, when the touch based remote assistance call button is pressed; determining that a missed scan event has occurred, when the third recognition result indicates that the detected quantity of products is greater than the quantity of products successfully scanned by the information code sensor; and determining that a checkout anomaly event has occurred, when the third recognition result indicates that the successfully detected product has disappeared.

Embodiment 7: The self-checkout method as described in Embodiment 6, the checkout interruption event includes one of the first type remote assistance call event, the second type remote assistance call event, the missed scan event, and the checkout anomaly event.

Embodiment 8: A self-checkout system includes: a self-service terminal comprising a control module configured to execute the following steps: continuously detecting the occurrence of a checkout interruption event; driving a plurality of sensors to capture a plurality of sensing information, executing a plurality of independent models to recognize the plurality of sensing information, thereby generating the plurality of recognition results, and determining whether the checkout interruption event has occurred accordingly; when the checkout interruption event occurs: disabling a first display device that provides a checkout operation, and forwarding the plurality of sensing information and the plurality of recognition results to a remote service station; and establishing a transmission connection with the remote service station, to allow a user to conduct a real-time communication with the remote service station through a second display device.

Embodiment 9: A self-checkout device includes: a control module configured to execute the following steps: continuously detecting the occurrence of a checkout interruption event; driving a plurality of sensors to capture a plurality of sensing information, executing a plurality of independent models to recognize the plurality of sensing information, thereby generating the plurality of recognition results, and determining whether the checkout interruption event has occurred accordingly; when the checkout interruption event occurs: disabling a first display device that provides a checkout operation, and forwarding the plurality of sensing information and the plurality of recognition results to a remote service station; and establishing a transmission connection with the remote service station, to allow a user to conduct a real-time communication with the remote service station through a second display device.

Embodiment 10: A self-checkout kit, attachable to a checkout management device, includes: a control module, integrated within the checkout management device or set separately but in a communicative connection with the checkout management device, configured to: continuously detect the occurrence of a checkout interruption event; drive a plurality of sensors to capture a plurality of sensing information, execute a plurality of independent models to recognize the plurality of sensing information, thereby generate the plurality of recognition results, and determine whether the checkout interruption event has occurred accordingly; when the checkout interruption event occurs: disable a first display device that provides a checkout operation, and forward the plurality of sensing information and the plurality of recognition results to a remote service station; and establish a transmission connection with the remote service station, to allow a user to conduct a real-time communication with the remote service station through a second display device.

Embodiment 11: The self-checkout kit as described in Embodiment 10 further includes one of the following: a first image sensor configured to capture a first image sensing information containing a hand; a second image sensor configured to capture a second image sensing information containing a product; the first image sensor configured to capture the first image sensing information containing an information code; a high-position image sensor configured to capture a third image sensing information containing the user, the hand, the product, or the information code; a first proximity sensor configured to detect a first distance information with respect to the hand, the product, or the information code, and obtain a first sensing information; a second proximity sensor configured to detect a second distance information with respect to the hand, the product, or the information code, and obtain a second sensing information; a third proximity sensor configured to detect a third distance information with respect to the hand, the product, or the information code, and obtain a third sensing information; an information code sensor configured to read the information code, and obtain a fourth sensing information; and the control module configured to: execute a gesture recognition independent model to recognize the first image and generate a first recognition result; execute an information code recognition independent model to recognize the first image and generate a second recognition result; execute an object recognition independent model to recognize the second image sensing information and generate a third recognition result; input the first to third recognition results, the first to third image sensing information, and the first to fourth sensing information into a checkout assistance decision independent model, execute the checkout assistance decision independent model to recognize a consuming behavior and determine whether a missed scan event has occurred; and when the missed scan event occurs: determining that the checkout interruption event has occurred.

Embodiment 12: The self-checkout kit as described in Embodiment 10, the checkout management device is a point of sale machine or a cash register.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. A self-checkout method, comprising:
at a self-service terminal, executing following steps through a control module:
continuously detecting an occurrence of a checkout interruption event;
driving a plurality of sensors to capture a plurality of sensing information, executing a plurality of independent models to recognize the plurality of sensing information, thereby generating the plurality of recognition results, and determining whether the checkout interruption event has occurred accordingly;
when the checkout interruption event occurs:
disabling a first display device that provides a checkout operation, and forwarding the plurality of sensing information and the plurality of recognition results to a remote service station; and
establishing a transmission connection with the remote service station, to allow a user to conduct a real-time communication with the remote service station through a second display device.

2. The self-checkout method as claimed in claim 1, further comprising:
at the self-service terminal, executing following steps through the control module:
driving the first display device to provide the user with the checkout operation;
driving the second display device to display a checkout assistance information to the user;
driving the plurality of sensors to capture the plurality of sensing information;
transmitting the plurality of sensing information and the plurality of recognition results to a remote server; and
when the checkout interruption event occurs:
temporarily disabling the first display device to interrupt the checkout operation, and instructing the remote server to transmit the plurality of sensing information and the plurality of recognition results to the remote service station; and
establishing the transmission connection with the remote service station, to enable the user to conduct a real-time audio and video streaming communication with the remote service station through the second display device.

3. The self-checkout method as claimed in claim 2, further comprising:
at the self-service terminal, executing the following steps through the control module:
driving a first image sensor to capture a first image sensing information containing a hand or an information code;
driving a second image sensor to capture a second image sensing information containing a product;
executing a gesture recognition independent model to recognize the first image sensing information and generating a first recognition result accordingly;
executing an object recognition independent model to recognize the second image sensing information and generating a third recognition result accordingly;
inputting the first and third recognition results into a checkout assistance decision independent model and executing the checkout assistance decision independent model to determine whether a missed scan event has occurred accordingly; and
when a missed scan event occurs:
determining that a checkout interruption event has occurred.

4. The self-checkout method as claimed in claim 3, further comprising:
at the self-service terminal, executing the following steps through the control module:
driving a high-position image sensor to capture a third image sensing information containing the user, the hand, the product, or the information code;
driving a first proximity sensor to detect a first distance information with respect to the hand, the product, or the information code, and obtaining a first sensing information accordingly;
driving a second proximity sensor to detect a second distance information with respect to the hand, the product, or the information code, and obtaining a second sensing information accordingly;
driving a third proximity sensor to detect a third distance information with respect to the hand, the product, or the information code, and obtaining a third sensing information accordingly;
driving an information code sensor to read the information code, and obtaining a fourth sensing information accordingly;
executing an information code recognition independent model based on the first image sensing information to produce a second recognition result;
inputting the first to third recognition results, the first to third image sensing information, and the first to fourth sensing information into the checkout assistance decision independent model, executing the checkout assistance decision independent model to recognize a consuming behavior for the user and determining whether a missed scan event has occurred; and
when a missed scan event occurs:
determining that a checkout interruption event has occurred.

5. The self-checkout method as claimed in claim 4, further comprising:
executing one of the following steps through the control module:
selectively driving the first display device to generate a touch based remote assistance call button; and
detecting whether a physical remote assistance call button or the touch based remote assistance call button has been pressed.

6. The self-checkout method as claimed in claim 5, wherein the checkout assistance decision independent model is configured to execute one of the following rules to determine whether the checkout interruption event has occurred:
determining that a first type remote assistance call event has occurred, when the physical remote assistance call button is pressed;
determining that a second type remote assistance call event has occurred, when the touch based remote assistance call button is pressed;
determining that a missed scan event has occurred, when the third recognition result indicates that the detected quantity of products is greater than the quantity of products successfully scanned by the information code sensor; and
determining that a checkout anomaly event has occurred, when the third recognition result indicates that the successfully detected product has disappeared.

7. The self-checkout method as claimed in claim 6, wherein the checkout interruption event includes one of the first type remote assistance call event, the second type remote assistance call event, the missed scan event, and the checkout anomaly event.

8. A self-checkout system, comprising:
a self-service terminal comprising a control module configured to execute the following steps:
continuously detecting the occurrence of a checkout interruption event;
driving a plurality of sensors to capture a plurality of sensing information, executing a plurality of independent models to recognize the plurality of sensing information, thereby generating the plurality of recognition results, and determining whether the checkout interruption event has occurred accordingly;
when the checkout interruption event occurs:
disabling a first display device that provides a checkout operation, and forwarding the plurality of sensing information and the plurality of recognition results to a remote service station; and
establishing a transmission connection with the remote service station, to allow a user to conduct a real-time communication with the remote service station through a second display device.

9. A self-checkout device, comprising:
a control module configured to execute the following steps:
continuously detecting the occurrence of a checkout interruption event;
driving a plurality of sensors to capture a plurality of sensing information, executing a plurality of independent models to recognize the plurality of sensing information, thereby generating the plurality of recognition results, and determining whether the checkout interruption event has occurred accordingly;
when the checkout interruption event occurs:
disabling a first display device that provides a checkout operation, and forwarding the plurality of sensing information and the plurality of recognition results to a remote service station; and
establishing a transmission connection with the remote service station, to allow a user to conduct a real-time communication with the remote service station through a second display device.

10. A self-checkout kit, attachable to a checkout management device, comprising:
a control module, integrated within the checkout management device or configured separately from but communicatively connected with the checkout management device, configured to:
continuously detect the occurrence of a checkout interruption event;
drive a plurality of sensors to capture a plurality of sensing information, execute a plurality of independent models to recognize the plurality of sensing information, thereby generate the plurality of recognition results, and determine whether the checkout interruption event has occurred accordingly;
when the checkout interruption event occurs:
disable a first display device that provides a checkout operation, and forward the plurality of sensing information and the plurality of recognition results to a remote service station; and
establish a transmission connection with the remote service station, to allow a user to conduct a real-time communication with the remote service station through a second display device.

11. The self-checkout kit as claimed in claim 10, further comprising one of the following:
a first image sensor configured to capture a first image sensing information containing a hand;
a second image sensor configured to capture a second image sensing information containing a product;
the first image sensor configured to capture the first image sensing information containing an information code;
a high-position image sensor configured to capture a third image sensing information containing the user, the hand, the product, or the information code;
a first proximity sensor configured to detect a first distance information with respect to the hand, the product, or the information code, and obtain a first sensing information;
a second proximity sensor configured to detect a second distance information with respect to the hand, the product, or the information code, and obtain a second sensing information;
a third proximity sensor configured to detect a third distance information with respect to the hand, the product, or the information code, and obtain a third sensing information;
an information code sensor configured to read the information code, and obtain a fourth sensing information; and
the control module configured to:
execute a gesture recognition independent model to recognize the first image and generate a first recognition result;
execute an information code recognition independent model to recognize the first image and generate a second recognition result;
execute an object recognition independent model to recognize the second image sensing information and generate a third recognition result;
input the first to third recognition results, the first to third image sensing information, and the first to fourth sensing information into a checkout assistance decision independent model, execute the checkout assistance decision independent model to recognize a consuming behavior and determine whether a missed scan event has occurred; and
when the missed scan event occurs:
determining that the checkout interruption event has occurred.

12. The self-checkout kit as claimed in claim 10, wherein the checkout management device is a point of sale machine or a cash register.
